(19) United States
(12) Patent Application Publication
(10) Pub. No.: US 2005/0227769 A1
(43) Pub. Date: Oct. 13, 2005

(54) Gaming device network managing system and method

(76) Inventors: James W. Morrow, Sparks, NV (US); Carmen DiMichele, Sparks, NV (US); Randy Osgood, Reno, NV (US)

Correspondence Address: BROWN RAYSMAN MILLSTEIN FELDER & STEINER, LLP, 1880 CENTURY PARK EAST, 12TH FLOOR, LOS ANGELES, CA, 90067, US

(21) Appl. No.: 11/092,179

(22) Filed: Mar. 28, 2005

Related U.S. Application Data
(63) Continuation-in-part of application No. 10/943,771, filed on Sep. 16, 2004.
(63) Continuation-in-part of application No. 11/065,771, filed on Feb. 24, 2005.
(63) Continuation-in-part of application No. 09/967,573, filed on Sep. 28, 2001, now Pat. No. 6,863,611.

(51) Int. Cl. G06F 19/00

(52) U.S. Cl. 463/42

(57) ABSTRACT

A method for managing gaming devices in a networked environment using a computer datastore includes: identifying one or more gaming devices within a network of gaming devices using one or more parameters associated with the gaming devices being identified, sorting one or more gaming devices identified within a network of gaming devices using one or more parameters associated with the gaming devices that were identified, and enabling the identified and sorted gaming devices to be targeted by an additional application/program for a target-specific management activity; thereby managing gaming devices with respect to various parameters that are associated with the gaming devices in the networked environment.

### RELATED APPLICATIONS

This application is a continuation-in-part of U.S. patent application Ser. No. 10/943,771 filed Sep. 16, 2004, entitled USER INTERFACE SYSTEM AND METHOD FOR A GAMING MACHINE, which is hereby incorporated herein by reference. This application is also a continuation-in-part of U.S. patent application Ser. No. 11/065,771 filed Feb. 24, 2005, entitled SYSTEM AND METHOD FOR AN ALTERABLE STORAGE MEDIA IN A GAMING MACHINE, which is hereby incorporated herein by reference. This application is also a continuation-in-part of U.S. patent application Ser. No. 09/967,573 filed Mar. 5, 2005, entitled TWO WIRE EXCHANGE SYSTEM, which issued Mar. 8, 2005 as U.S. Pat. No. 6,863,611, all of which are hereby incorporated herein by reference.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

1. Field of the Invention

This invention relates generally to a system and method for tracking and dynamically sorting gaming devices, and more particularly, to a system and method for tracking, dynamically sorting, and managing gaming devices with respect to various qualities and/or parameters that are possessed by those gaming devices.

2. Background of the Invention

Traditionally, gaming machines have been designed for gaming purposes only. In this regard, gaming machines have been constructed only to include gaming functionality. Recently, however, casino owners have become aware that by adding additional features to gaming machines, they may be able to maintain a player's attention to the gaming machines for longer periods of time. This, in turn, leads to the player wagering at the gaming machine for longer periods of time, thereby increasing casino profits.

One technique that has been employed to maintain a player's attention at the gaming machine has been to provide players with access to gambling-related information. By attaching a small electronic display to the gaming device, gambling-related information, as well as news and advertisements can be sent to the player. The gambling-related information may include, for example, information on sports betting and betting options for those sporting events. Additionally, the gambling-related information may also include information such as horse racing and off-track betting. News and advertisements can also maintain a player's attention by providing the player with access to information ranging from show times, to restaurant and hotel specials, and to world events, thus reducing the need and/or desire for the player to leave the gaming machine.

Moreover, it would be desirable to provide the player with interactive access to the above information. This type of interactivity would allow players significantly more flexibility to make use of the above-described information. The gambling-related information could also be utilized by the player in a much more efficient manner. In this regard, greater levels of flexibility and access are likely to make a player remain and gamble at the gaming machine for significantly longer periods of time. Unfortunately, the system components that are currently utilized for displaying and accessing this type of information, such as external keypads and display modules, are extremely limited in the functionality and capabilities that they provide, thus limiting the success of their ability to maintain a player's attention.

As stated above, attempts to distribute gambling-related information and advertisements to players, has typically required additional system components to be attached to the gaming devices separately and apart from the construction of the gaming machine itself. Specifically, these components for accessing and displaying information from gaming machines have been extremely limited in their usefulness because of the lack of capabilities inherent in these components. Such components have generally included a keypad, card reader, and display equipment, such as a 2-line LED display. It would be desirable for these components to be integrated into the gaming device itself, in a more unified fashion to provide substantially greater functionality than that which has been previously available.

Additionally, it would be desirable to be able to track and dynamically sort gaming devices with respect to various qualities and/or parameters that are possessed by those gaming devices, including new components for integrating expanded service and systems capabilities with the more traditional function of a gaming device. Accordingly, those skilled in the art have long recognized the need for a system that is capable of integrating expanded service and systems capabilities with the more traditional function of a gaming device. The claimed invention clearly addresses these and other needs.

### SUMMARY OF THE INVENTION

Briefly, and in general terms, the claimed invention resolves the above and other problems by providing a method for managing gaming devices in a networked environment using a computer datastore. The method includes identifying one or more gaming devices within a network of gaming devices using one or more parameters associated with the gaming devices being identified; sorting one or more gaming devices identified within a network of gaming devices using one or more parameters associated with the gaming devices that were identified; and enabling the identified and sorted gaming devices to be targeted by an additional application/program for a target-specific management activity; thereby managing gaming devices with respect to various parameters that are associated with the gaming devices in the networked environment.

In one preferred embodiment, gaming peripherals, as well as gaming devices, are identified, sorted, and enabled for targeting by an additional application/program for a target-specific management activity. In this manner, the claimed invention enables increased performance through the use of distributed processing, where processing is distributed amongst various gaming devices and gaming peripherals, instead of a model in which processing power is centralized in the gaming processor itself. Preferably, in such a distributed processing system, a two wire exchange system (a complete description of which has been incorporated by reference above) is used to enable effective communication between all of the various gaming devices and gaming peripherals.

In accordance with one aspect of a preferred embodiment, the gaming devices include, by way of example only, and not by way of limitation, electronic gaming machines, game monitoring units, embedded additional user interface, embedded components, bill dispensers, coin acceptors, hoppers, and printers, as well as any uniquely identifiable entity on the gaming floor. In another aspect of a preferred embodiment, the datastore includes, by way of example only, and not by way of limitation, a relational database, an object database, a flat file, an ASCII list, registry entries, an XML file, and data listings. Continuing, in still another aspect of a preferred embodiment, the parameters include, by way of example only, and not by way of limitation, the name of the gaming device, the hardware revision of the gaming device, the firmware revision of the gaming device, the content on the gaming device, the make/model of the gaming device, the physical location of the gaming device, component list, and logs (e.g., application logs, component logs, access logs, and the like).

Preferably, in one embodiment, the target-specific management activity includes, by way of example only, and not by way of limitation, tracking, sorting, managing, polling, auditing, querying, downloading, uploading, verifying, authenticating, updating, and reconfiguring. In one specific embodiment, all gaming devices that are identified and sorted into a particular group are targeted for a specific code download. In another specific embodiment, all game monitoring units that are identified and sorted into a particular group are targeted for a particular code revision while those game monitoring units outside of the group are ignored.

Continuing, in still another specific embodiment, all embedded additional user interfaces installed into gaming machines that are located in a particular physical location on a property are identified, receive downloaded content, and have said downloaded content authenticated, after which the embedded additional user interfaces in said physical location are reconfigured in response to an initiating event, while all of the embedded additional user interfaces outside of said physical location are ignored. Preferably, the computer datastore identifies, sorts, and groups gaming floor inventory for inventory (or asset) management. Accordingly, in one preferred embodiment, the computer datastore maintains up-to-date information on gaming floor inventory for one or more parameters associated with the gaming devices.

In accordance with another preferred aspect, an embedded additional user interface is used in a gaming machine, wherein the gaming machine includes at least one gaming screen and a gaming processor. More particularly, the embedded additional user interface includes a web content capable display screen and an embedded processor. Preferably, the web content capable display screen presents web information to a user via the display screen and also acts as a user input device. The embedded processor preferably utilizes an internal operating system and communicates with the gaming processor. Preferably, the embedded processor reads incoming data, translates the data into a web protocol (web authoring language), if necessary, and maps the data to the web content capable display screen. In this manner, the web content capable display screen increases user excitement by providing a richer gaming experience.

In accordance with another aspect of a preferred embodiment, the incoming data received by the embedded additional user interface are I²C messages (or other serial communications). Preferably, the embedded processor communicates with the gaming processor, and/or other connected devices, over an I²C bus (RS-232, USB, or other serial communications bus). The web content capable display screen of the embedded additional user interface is preferably a color graphic touch screen display. Preferably, the embedded processor is at least a 32-bit processor. Further, the internal operating system of an embedded additional user interface is preferably customized to match the specific hardware to which the internal operating system attaches.

In accordance with another aspect, bi-directional communication between the underlying gaming machine and the embedded additional user interface is accomplished using a variety of methods, including, but not limited to, using a USB connection or hub. For older gaming machines that may not support USB technology, an RS-232, or parallel connection with a null modem crossover send/receive wire may be used for bidirectional communications.

In accordance with another aspect of a preferred embodiment, the embedded processor utilizes cryptographic technology. In one preferred embodiment, a certification process is offered for authentication and non-repudiation of the web content. Preferably, the certification process provides auditability and traceability. Specifically, the certification process provides sufficient security for gaming regulators to allow casino operators to design their own content.

In accordance with another aspect of a preferred embodiment, HTML is the web protocol into which the incoming data is translated in the embedded additional user interface. In another preferred embodiment, DHTML is the web protocol into which the incoming data is translated in the embedded additional user interface. In still another preferred embodiment, XML is the web protocol into which the incoming data is translated in the embedded additional user interface. In yet another preferred embodiment, MACROMEDIA FLASH animation technology is the web protocol into which the incoming data is translated in the embedded additional user interface. In one preferred embodiment, the embedded additional user interface connects to an Ethernet-networked backbone. Further, in one preferred embodiment, the embedded additional user interface connects to a web server through an Ethernet-networked backbone. In another preferred embodiment, the embedded additional user interface connects to a web server through ATM (asynchronous transfer mode) or other style of network, such as fiber optic.

In another preferred embodiment, the embedded additional user interface includes an animation capable display screen and an embedded processor. In yet another preferred embodiment, the embedded additional user interface includes a web page display screen and an embedded processor. In still another preferred embodiment, the embedded additional user interface includes a multimedia display screen and an embedded processor.

In accordance with another preferred embodiment, the claimed invention is directed towards an embedded additional user interface that is incorporated into a gaming machine that includes a separate gaming screen (or gaming region, e.g., spinning reels). The embedded additional user interface includes a web content capable display screen and an embedded processor. Preferably, the web content capable display screen presents web information to a user via the display screen. The embedded processor preferably utilizes an internal operating system. The embedded processor reads incoming data, translates the data into a web protocol (web authoring language), if necessary, and maps the data to the web content capable display screen. Furthermore, in this embodiment the embedded processor additionally includes standard gaming processor functionality, and as such, replaces the standard gaming processor in the gaming machine. Moreover, in such an embodiment in which the embedded processor additionally includes standard gaming processor functionality, this processor supports system gaming (i.e., gaming over the network in which the games are centrally controlled).

In accordance with another preferred embodiment, the claimed invention is directed towards a gaming machine that includes an embedded additional user interface having a web page display screen. Preferably, the gaming machine includes a gaming display screen, a gaming processor, and an embedded additional user interface. The embedded additional user interface further includes the same web page display screen and an embedded processor that has been described above.

In accordance with another preferred embodiment, the claimed invention is directed towards a method for increasing user excitement relating to a gaming machine by providing a richer gaming experience via an embedded additional user interface that is incorporated into the gaming machine. Preferably, the embedded additional user interface includes an embedded processor and a web page display screen. The method preferably includes: receiving a serial data message containing enhanced player information over a serial communication bus (e.g., an I²C bus) in the embedded additional user interface; translating the data message into a web authoring language, if necessary; and mapping the data message to the web page display screen, wherein the display screen presents web page information to a user via the display screen.

In one embodiment, the web content is protected by digital signature verification using DSA (Digital Signature Algorithm) or RSA (Rivest-Shamir-Adleman) cryptographic technology (SHA-1 or better). In this regard, the content is preferably protected using digital signature verification so that any unauthorized changes are identifiable. Of course, other suitable protection techniques may also be used in other embodiments.

Still further, one preferred embodiment utilizes a Message Authentication Code (MAC), which may be used to verify both the content integrity and the authenticity of a message. A Message Authentication Code can be generated faster than using digital signature verification technology, although it is not as robust. In one preferred embodiment, the authentication technique utilized is a BKEY (electronic key) device. A BKEY is an electronic identifier that is tied to a particular trusted authority.

Typically, in a preferred embodiment, the data is authenticatible and non-repudiatible, rather than hidden or otherwise obfuscated. Non-repudiation is a way to guarantee that the sender of a message cannot later deny having sent the message, and that the recipient cannot deny having received the message.

In accordance with one preferred embodiment, one or more gaming machine system or embedded additional user interface components (or content) are assigned identification codes. The components are grouped together into a protected group of component bindings using cryptographic security procedures and the identification codes of the components in the bindings group. Accordingly, the bindings prevent falsification or repudiation of content entries with respect to any modifications or replacements of components or content within the bindings group.

In accordance with another aspect of a preferred embodiment, every content entry must be authenticated by being digitally. signed with a Hashed Message Authorization Code that is based on the entry itself and on the individual identification codes of the components and content in the bindings group. In the same manner, every entry that attempts a replacement of any of the embedded additional user interface components or content must be authenticated by being digitally signed with a Hashed Message Authorization Code that is based on the entry itself and on the individual identification codes of the components and content in the bindings group.

Preferably, the identification codes of the embedded additional user interface components are randomly or pseudo-randomly generated. In accordance with another aspect of the verification system, a Hashed Message Authorization Code key for authenticating access to the component bindings is produced using a SHA-1 (or better) hash that is generated using the individual identification codes of the components in the bindings group. Additionally, the embedded additional user interface components are secured within the component bindings using a SHA-1 (or better) hash that is generated using the individual identification codes of the components and content in the bindings group.

Other features and advantages of the claimed invention will become apparent from the following detailed description when taken in conjunction with the accompanying drawings, which illustrate by way of example, the features of the claimed invention.

### BRIEF DESCRIPTION OF THE DRAWINGS

FIG. 1A illustrates a relational diagram of an computer datastore, constructed in accordance with the claimed invention, that identifies, dynamically sorts, and manages gaming devices with respect to various qualities and/or parameters that are possessed by those gaming devices;

FIG. 1B illustrates a relational diagram of an embedded additional user interface utilizing a web page display screen and an embedded processor that receives data messages from a game monitoring unit that are translated into web page content and mapped to the web page display screen;

FIG. 2 illustrates a relational diagram of a prior art gaming system that utilizes a 2×20 VF display and 12-digit keypad;

FIG. 3 illustrates a relational diagram of embedded additional user interface, constructed in accordance with the claimed invention, utilizing a web page display screen and an embedded processor that receives cryptographically certified web page content from a portable computer via a network adapter port;

FIG. 4 illustrates a relational diagram of embedded additional user interface, constructed in accordance with the claimed invention, utilizing a web page display screen and an embedded processor that receives web page content from a back-end server via an Ethernet-networked backbone;

FIG. 5 illustrates a relational diagram of embedded additional user interface, constructed in accordance with the claimed invention, utilizing a web page display screen and an embedded processor that includes the finctionality of a standard gaming processor;

FIG. 6 illustrates an object interaction diagram of embedded additional user interface, constructed in accordance with the claimed invention;

FIG. 7 is a diagram showing the sequence of events that occur when data is sent between the of embedded additional user interface and the game monitoring unit;

FIG. 8 is a diagram showing the sequence of events that occur when a virtual key is press on the web page display screen; and

FIG. 9 is a logical flow diagram of a preferred method, constructed in accordance with the claimed invention, for identifying, dynamically sorting, and managing gaming devices with respect to various qualities and/or parameters that are possessed by those gaming devices.

### DETAILED DESCRIPTION OF THE PREFERRED EMBODIMENTS

Briefly stated, a preferred embodiment of the datastore, constructed in accordance with the claimed invention, is directed towards tracking, dynamically sorting, and managing gaming devices with respect to various qualities and/or parameters that are possessed by those gaming devices. Such gaming devices include an electronic gaming machine itself, or embedded components, such as a GMU (Game Monitoring Unit) or an embedded additional user interface (referred to sometimes herein as an iView device). Such gaming devices further include any uniquely identifiable entity on the gaming floor, including by way of example only, and not by way of limitation, gaming-related signage and kiosks.

Gaming-related signage relates to advertising signage that is typically in a reconfigurable electronic format. In this context, gaming-related kiosks are machines that provide gaming-related service but do not provide actual game play itself. Gaming-related kiosks may include both patron-oriented services and maintenance-oriented features. In one embodiment, patron-oriented services include the ability to sign on to rewards services, view account status and history, redeem payout tickets and promotional “comps,” request help from an attendant, order drinks, make dinner reservations, reserve taxis, purchase show tickets, conduct banking transactions, and the like. Maintenance-oriented features include providing information such as coin-in, coin-out, malfunctions, jackpots, tilt conditions, game software version, and the like.

As described below, an embedded additional user interface is preferably integrated into a gaming machine and acts to increase user excitement by providing a richer gaming experience. An embedded additional user interface provides enhanced player satisfaction and excitement, as well as improved gaming device reliability, interactivity, flexibility, security, and accountability. The user interface is sometimes referred to herein as “additional” in that the user interface is separate from the gaming screen (or other gaming presentation). Further, the user interface is sometimes referred to herein as “embedded” in that the user interface includes its own processor in some preferred embodiments of the invention. Preferably, the datastore may comprise a relational database, object database, a flat file, an ASCII list, registry entries, an XML file, a “collection” (i.e., in a SQL (structured query language) environment, a collection of parameter defined data in an object database), or any other type of commonly known data listing.

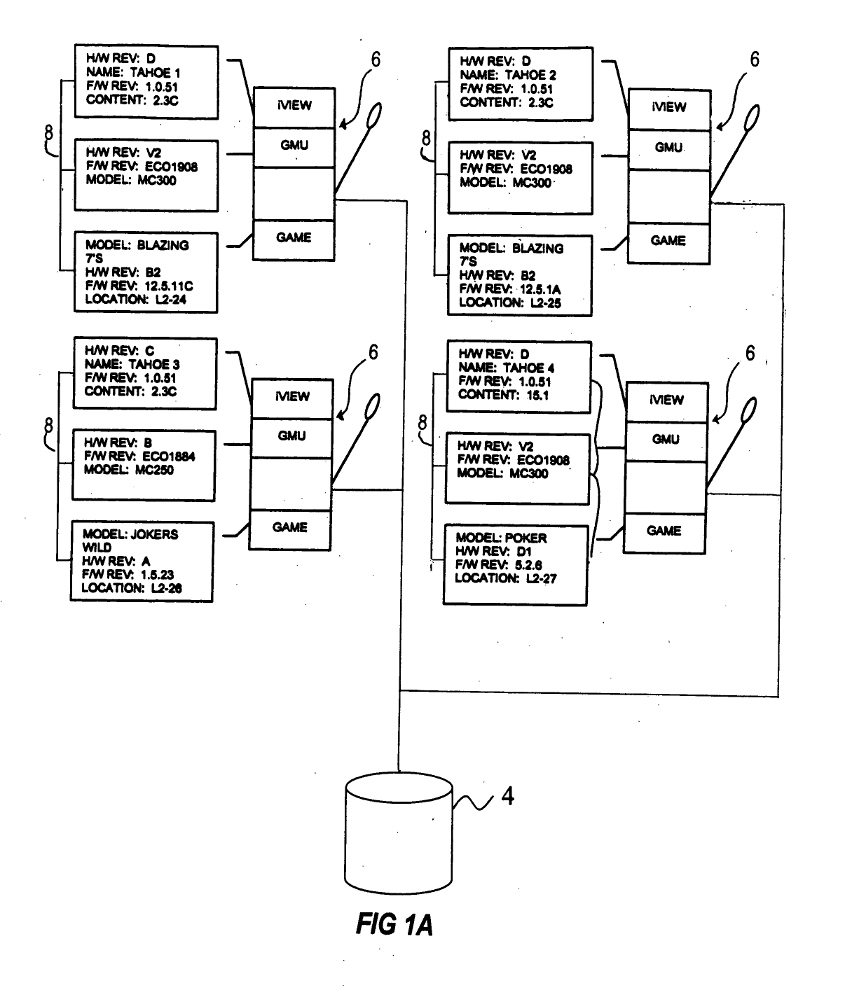

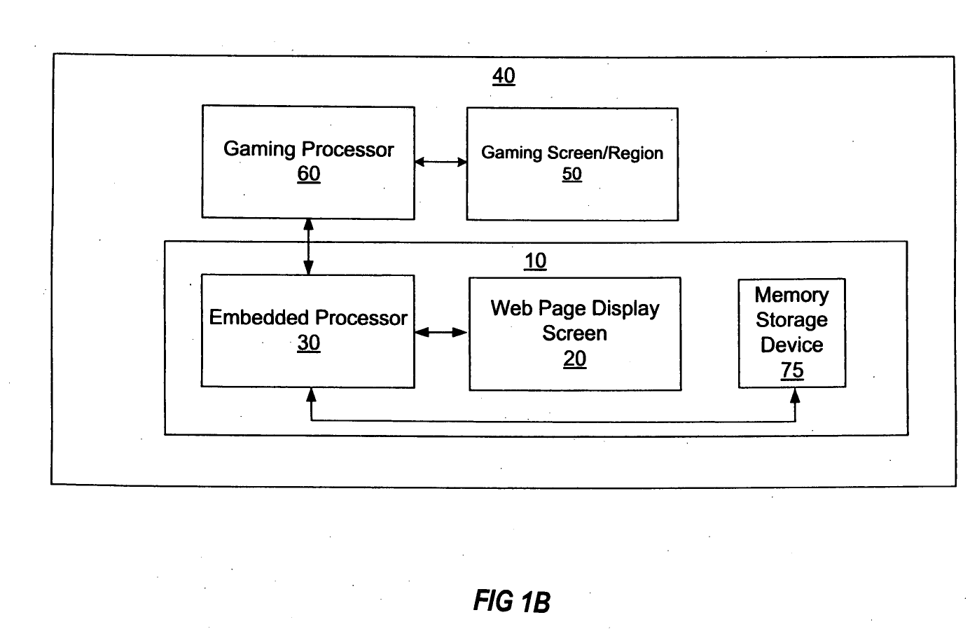

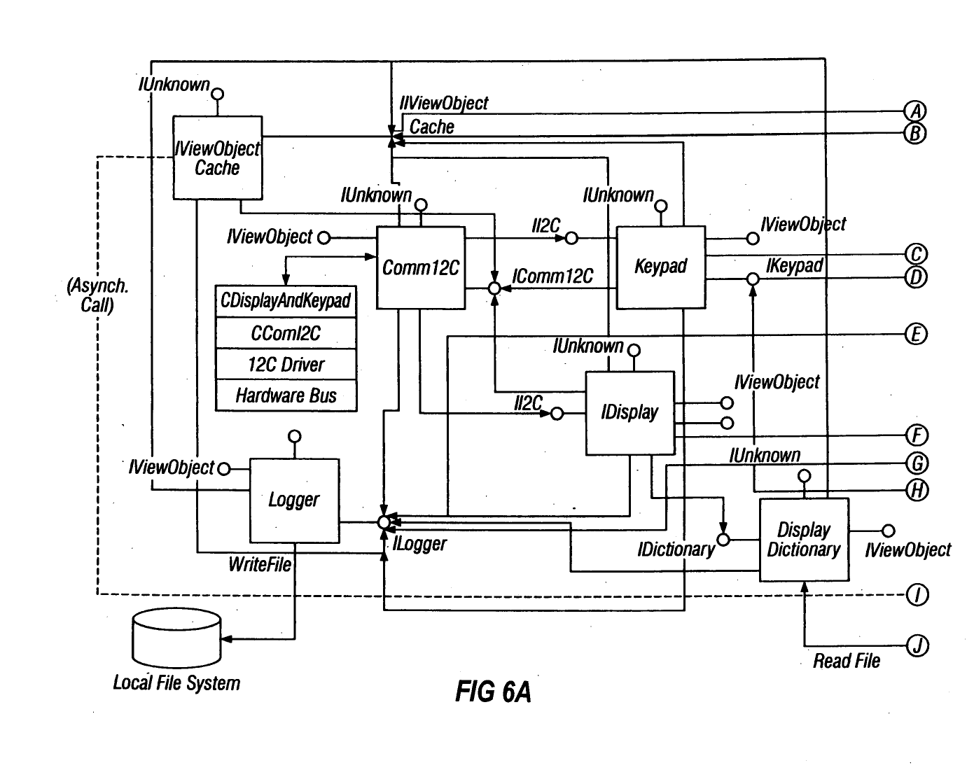

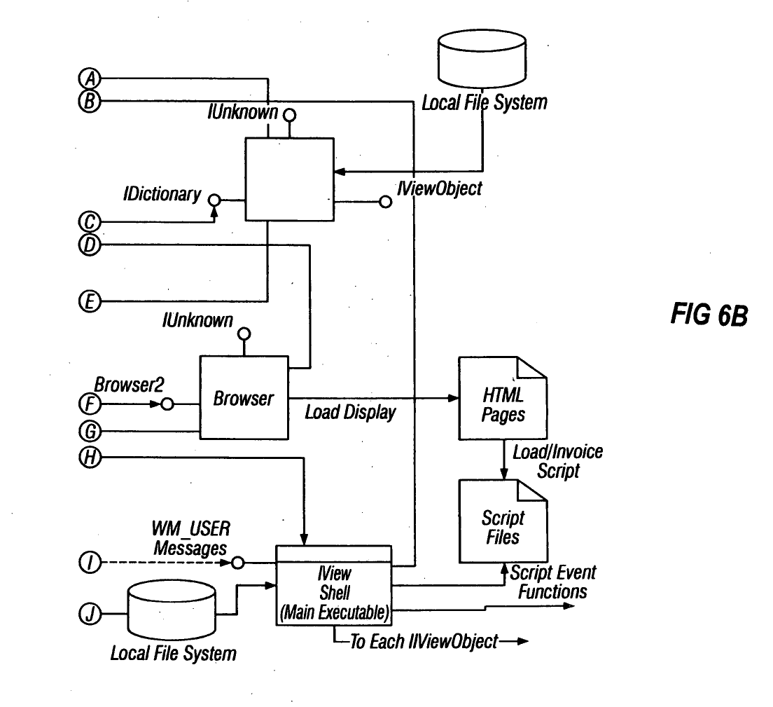

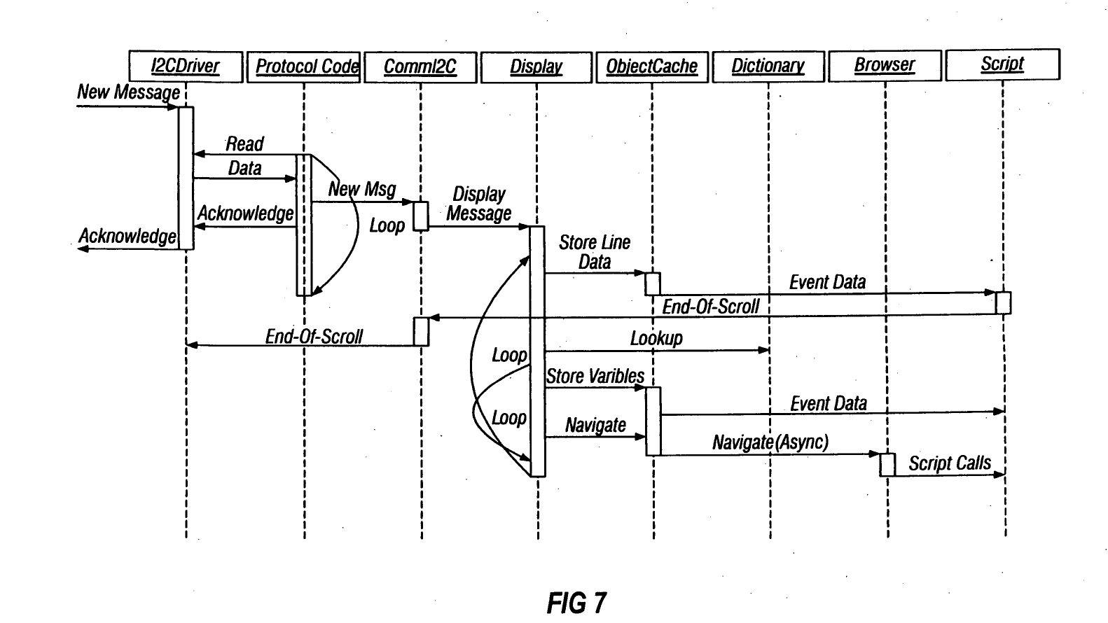

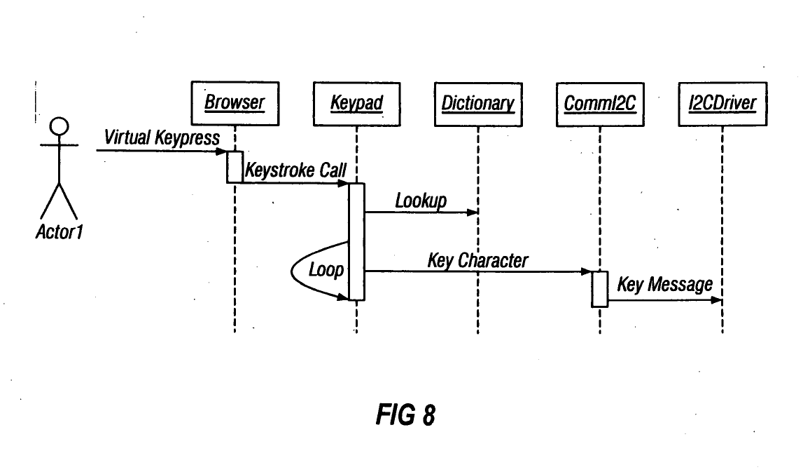

Referring now to the drawings, wherein like reference numerals denote like or corresponding parts throughout the drawings and, more particularly to FIGS. 1A-9, there is shown one embodiment of computer datastore 4 constructed in accordance with the claimed invention. Specifically, FIG. 1A shows a computer datastore 4 that enables tracking, dynamically sorting, and managing gaming devices 6 with respect to various qualities and/or parameters 8 that are possessed by those gaming devices. Preferably, any gaming device, once it has been identified and sorted by the claimed invention, can be organized as a member of one or more groups or “collections” of gaming devices 6. Theses groups of gaming devices 6, after being sorted by the datastore 4 of the claimed invention, are preferably made available to software programs that use this data to target this gaming device group for various purposes. Such purposes include, by way of example only, and not by way of limitation: tracking, sorting, managing, polling, querying, downloading, uploading, verifying, authenticating, updating, reconfiguring, auditing, logging, options, auditing (for revenue discrepancies) and the like.

In a preferred embodiment, the computer datastore 4 of the claimed invention provides a significantly desirable ability to sort gaming devices 6 by feature, whether the gaming devices are electronic gaming machines (EGMs), GMUs, embedded additional user interfaces 10, or any other uniquely identifiable entity on the gaming floor. In one aspect of a preferred embodiment, the gaming devices 6 being tracked and/or sorted by the claimed invention have a download feature that is sortable according to: (a) the make/model of the gaming device that the download feature is associated therewith, (b) the device's hardware revision, (c) the device's firmware revision, (d) the physical location of the gaming device on the property, (e) zoning of the gaming device (e.g., high roller zone), (f) game type (e.g., mechanical, electrical, dual screen, and the like), (g) dynamic gaming state or state change (e.g., payout, malfunction, “game in use,” offline, tilt, jackpot mode, turned off, authentication failure, security breach, downloading content, installing content, and the like) or (h) other suitable sorting feature.

In one exemplary embodiment, all gaming devices 6 in a particular group can then be targeted for a specific code download. Accordingly, in one specific embodiment all GMUs with a particular code revision can be identified and upgraded while those GMUs outside of the group are ignored. In another example, all embedded additional user interfaces 10 installed into gaming machines that are located in a particular physical location on the property (i.e., a particular bank of games) are identified, receive downloaded content which is then authenticated, after which they are reconfigured. Meanwhile, all of the embedded additional user interfaces 10 outside of that grouping are ignored.

As mentioned above, the computer datastore 4 of the claimed invention can also utilize these sorting and grouping capabilities for the purpose of inventory management. In this regard, a property (e.g. casino) is able to maintain up-to-date information on gaming floor inventory for a multitude of inventory parameters 8. These inventory parameters 8 include, by way of example only, and not by way of limitation, the name of the embedded additional user interface 10, the hardware revision of the embedded additional user interface 10, the firmware revision of the embedded additional user interface 10, the content of the embedded additional user interface 10, the make/model of the GMU, the hardware revision of the GMU, the firmware revision of the GMU, the make/model of the gaming machine, the hardware revision of the gaming machine, the firmware revision of the gaming machine, and the physical location of the gaming machine.

In one preferred embodiment, the claimed invention either queries a datastore 4 containing all of the gaming device inventory data or performs the query itself. In such an embodiment, the invention is embodied in a software application. The invention then sorts the data according to one or more user-input parameters 8. After the sorting has occurred, the user can, for example, download new content to these two iView devices 6 now that the device has been identified and targeted.

Since the device data resides on a central computer datastore 4, standard binary datastore searches can be performed to produce specifically desired reports. However, in one preferred embodiment, a distributed datastore 4 is used instead of a centralized datastore. In one particular example, an analyst may be interested in the effectiveness of one piece of content (content X) compared to another piece of content (content Y) in a particular brand of gaming machine. Using the claimed invention, the analyst can perform a datastore 4 query on various parameters of the gaming devices 6, for example, the “coin-in” count on all Blazing 7's style gaming machines with iView gaming devices running content version X and content version Y. In this manner, the claimed invention enables specialty reporting, efficiency analysis, and gaming device management with a level of organization and simplicity that was never before possible.

In another embodiment, the standard binary datastore 4 searches are performed to produce other specifically desired reports, such predictive analysis and yield management. In one embodiment, the yield management data includes projection data calculated based on one or more factors related to use of one or more gaming machines. For example, in one embodiment, the yield management data includes game play projection data, machine usage projection data, and/or income projection, data calculated based historical game play data for the one or more gaming machines. In one embodiment, the calculations are performed using linear regression analysis. In another embodiment, the calculations are performed using a neural network. In one embodiment, yield management data is used to determine one or more bonuses.

Referring now to FIG. 1B, an embedded additional user interface 10 that includes a web page display screen 20 and an embedded processor 30 is shown. The user interface 10 is incorporated into a gaming machine 40 that, in turn, includes a gaming screen 50, (and/or non-screen gaming region 50, e.g., spinning reels or other gaming presentation) gaming processor 60, and a game monitoring unit 65. The embedded processor 30 employs an internal operating system and communicates with the gaming processor 60. The embedded processor 30 reads incoming data, translates the data into a web authoring language, and maps the data to the web page display screen 20. The display screen 20 presents web page information to a user via the display screen, thereby increasing user excitement by providing a richer gaming experience. The game monitoring unit 65 monitors the information that is input through the user interface 10. This provides a dramatic improvement over traditional system components 70 (input/output peripherals, such as 2-line, 20 character VF (Vacuum Fluorescent) displays and 12-digit keypads) that have been used as in the past to provide user information. The user interface 10 communicates with the game monitoring unit 65 in the same manner as the previous system components 70 communicated with the game monitoring unit.

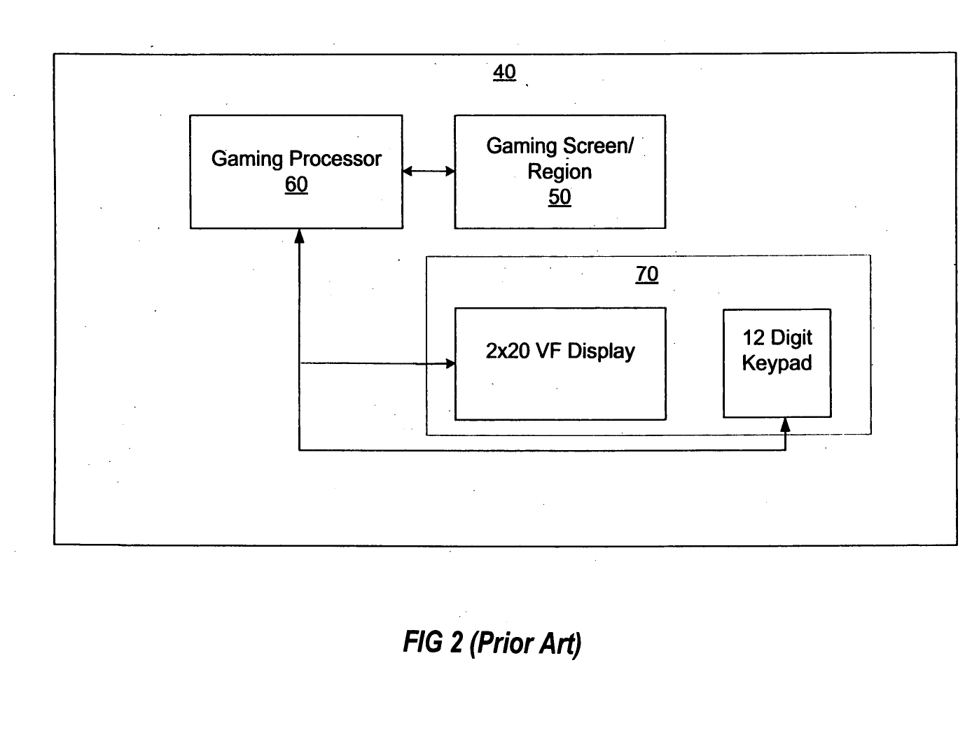

As shown in FIG. 2, prior art gaming devices typically utilized a single video display screen as a gaming screen 50 for the gaming machine 40, while additional system components 70 were attached orjuxtapositioned next to the gaming machine. However, in a preferred embodiment of the claimed invention, the system components 70 that were used in prior art systems are replaced with the embedded additional user interface 10 to provide the advanced finctionality of a web page display screen 20. Such finctionality includes, by way of example only, and not by way of limitation, the ability to display animation, multimedia, and other web-type content. The embedded additional user interface 10 enables presentation of additional information (e.g., enhanced player information) to a player (or potential player) through the web page display screen 20 in an exciting, eye-catching format, while not interfering with the normal gaming processes being displayed on the gaming screen 50. Further, the embedded additional user interface 10 does not interfere with the normal gaming hardware in the gaming machine 40, but rather is easily integrated into a gaming machine 40.

Referring again to FIG. 1B, in situations involving multiple gaming machine (or gaming component) manufactures, an embedded additional user interface 10 can be incorporated into a gaming machine (either originally or by retrofitting) without requiring access to the game logic or other gaming systems that might be proprietary and inaccessible with a gaming machine from another gaming manufacturer. Thus, in a preferred embodiment of the claimed invention, the embedded additional user interface 10, which includes a web page display screen 20 for presenting supplementary information to a player, is incorporated into a gaming machine 40 in addition to the standard gaming screen 50 typically found in a gaming machine. The embedded additional user interface 10 may also be incorporated into a gaming machine 40 that utilizes a gaming region (e.g., a reel-spinner) instead of a standard gaming screen 50. This supplemental information may include general gaming information, player specific information, player excitement and interest captivation content, advertising content (targeted or otherwise), and the like. Further, in other preferred embodiments, the embedded additional user interface 10 may have the ability to interact with the game logic of the gaming processor 60, and thus, provide further functionality, such as bonus games and/or the ability to incorporate awards, promotional offers, or gifts from the web page display screen 20 to the gaming screen 50. Moreover, the web page display screen 20 may display supplemental information in an “attract mode” when there is no game play occurring.

In a preferred embodiment of the claimed invention, the embedded additional user interface 10 is used to make casino services more accessible and friendly to casino patrons. In one preferred embodiment, the embedded additional user interface 10 is designed to interface with the hardware configuration of game platforms currently employed in an existing gaming communication systems network, thus decreasing implementation costs for the casino. A standard gaming network interface to the systems network, such as a Mastercom system, includes a multi-drop bus method of communicating to a keypad and display. The Mastercom system is available from Bally Manufacturing, and is described in U.S. Pat. No. 5,429,361 to Raven et al. incorporated herein by reference. One such currently utilized bus is an EPI bus (Enhanced Player Interface bus), which uses industry standard I²C hardware and signaling.

In one preferred embodiment, the embedded additional user interface 10 is used to replace/upgrade an EPI bus. Preferably, the embedded additional user interface 10 replaces the EPI bus in the gaming machine in a “plug and play” manner. In other words, the old EPI bus can be unplugged and the new embedded additional user interface 10 can simply be plugged into the I²C bus of the gaming machine 40, where the user interface 10 utilizes the currently employed industry standard I²C hardware and signaling without requiring any further modification. The embedded processor 30 of the embedded additional user interface 10 reads incoming I²C data (content), translates the data into a web authoring language (e.g., HTML, DHTML, XML, MACROMEDIA FLASH), and maps the data to the web page display screen 20. In this manner, the previous I²C data messages, which were typically presented on a 2-line, 20 character VF display, are automatically transformed by the embedded additional user interface 10 into an attention grabbing, animated (multimedia) web page style format. This results in enhanced player satisfaction and excitement with extremely minimal retrofitting requirements.

Since, in one preferred embodiment, the embedded additional user interface 10 utilizes I²C hardware and signaling, this enables the user interface 10 to speak and understand the I²C protocol message set, and thus, communicate directly with the gaming processor 60 of the gaming machine 40 (or other networked devices) in the same fashion in which the gaming processor previously communicated with the EPI bus. Accordingly, in a preferred embodiment of the claimed invention, the functionality of the previously utilized hardware (e.g., the EPI bus) is replaced and substantially upgraded with the integration of the embedded additional user interface 10 into the gaming machine 40. As such, the external hardware of any such system components (e.g., a keypad and a 2-line, 20 character VF display) is eliminated.

As stated above, in one preferred embodiment, the incoming data received by the embedded additional user interface 10 is I²C signaling protocol; however, in other preferred embodiments other serial communication protocols (or electronic communication format) are utilized. Preferably, the embedded processor 30 communicates with the gaming processor 60, and/or other connected devices, over an I²C bus (or over another serial communications bus in embodiments that utilize another protocol). The web page display screen 20 of the embedded additional user interface 10 is preferably a color-graphic touch screen display. Preferably, the embedded processor 30 is at least a 32-bit processor. A preferred embodiment utilizes a 32-bit processor because cryptographic techniques, such as SHA-1 and DSA algorithms, are written and operate natively on a 32-bit system. Additionally, the Microsoft® Windows® environment, which is utilized in some preferred embodiments of the claimed invention, is also 32-bit. Further, the internal operating system of the embedded additional user interface 10 is preferably customized to match the specific hardware to which the internal operating system attaches.

Preferably, the embedded additional user interface 10 is an embedded computer board that, in addition to the embedded processor 30 and the web page display screen 20, further includes removable alterable media 75 (e.g., COMPACT FLASH card, hard drive, secure digital card, or other memory storage device), as shown in FIG. 1B, and a network adapter port. In one embodiment, content and feature updates to the embedded additional user interface 10 are accomplished by physically swapping out the COMPACT FLASH card 75 (or other alterable media). Thus, one manner in which data is retrievable from the embedded additional user interface 10 is by physically removing and reading the COMPACT FLASH card 75. Another manner in which data is retrievable from the embedded additional user interface 10 is through a network connection, or other communication port. Additionally, the alterable media 75 can be used to download data (or other content) as well as upload data (or other content).

In one preferred embodiment, the internal operating system utilized by the embedded processor 30 of the embedded additional user interface 10 is WINDOWS® CE version 4.2 (or higher). Preferably, the embedded additional user interface 10 is built upon a PXA255-based board developed by the Kontron Corporation. Additionally, in a preferred embodiment of the embedded additional user interface 10, the browser control for the web page display screen 20 is MICROSOFT® INTERNET EXPLORERS®6.0 (or higher), which is shipped standard with WINDOWS® CE 4.2, the preferred internal operating system for the embedded processor 30.

A preferred embodiment of the embedded additional user interface 10 also provides a mechanism for inputting system information into, and retrieving system information from, the game machine 40. As stated above, the embedded additional user interface 10 preferably uses industry standard I²C hardware and signaling. The I²C protocol has multi-master capabilities, i.e., is capable of participating as both a slave and as a master. The embedded additional user interface 10 enables system information (such as information input by a player into a web page display screen 20) to be sent from the game machine 40 to a slot system network (or to another destination location). Likewise, the embedded additional user interface 10 also enables the system information (such as display messages) to be sent from the systems network (or from another source location) to the game machine 40 for viewing by the player through the web page display screen 20.

In a preferred embodiment, information can also be input by a user into the web page display screen 20 of the user interface 10. The web page display screen 20 of the user interface 10 employs a virtual keypad. Further, the user interface 10 uses a keypad dictionary that allows a user to be able to enter a vastly greater amount of information than was previously possible using a 12 digit VF keypad. For example, the virtual key on the touch screen that is displayed by the browser is pressed by a user. This calls the Keypad object by calling its Dispatch interface with a string that identifies which virtual key was pressed. The Keypad object looks up the string in the Dictionary object which has been loaded at initialization time with a set of keys to return when that string is passed to it. When it retrieves this set of zero or more key characters, it passes them to the GMU by calling the interface exposed by the object.

Typically, a network interface (or equivalent system) is used to control the flow of funds used with the gaming machine 40 within a particular casino. By utilizing the embedded additional user interface 10 of the claimed invention, the gaming network interface can be instructed to move funds between player's accounts and gaming machines by merely touching the web page display screen 20. In addition, many other more sophisticated commands and instructions may be provided. Thus, the embedded additional user interface 10 improves the player and casino employee interface to the gaming machine 40, directly at the gaming device itself.

In a preferred embodiment of the claimed invention, the web page display screen 20 of the embedded additional user interface 10 enables a player to be shown player messages in an animated, multimedia, web content style environment. These messages would previously have been displayed in a significantly more mundane format on a separate display device (e.g., a 2-line VF display device). In some preferred embodiments, touch screen buttons in the web page display screen 20 are used by the player to navigate between windows in web page display screen 20 and allow access to system functions such as cashless withdraw, balance requests, system requests, points redemption, and the like. In other preferred embodiments of the claimed invention, the web page display screen 20 utilizes various other data input techniques commonly known in the art, instead of the touch screen data entry. Thus, implementation of the embedded additional user interface 10 is an efficient, highly beneficial, and substantial upgrade to a gaming machine 40 that greatly increases the functionality over what was previously possible using an EPI bus.

In one preferred embodiment, text data messages are translated into web page navigation requests by the embedded processor 30 and then displayed on the web page display screen 20. Script languages, such as JAVA SCRIPT and VB SCRIPT, are also utilized for some of the web pages. Preferably, the embedded additional user interface 10 emulates the 12-digit keypad and the 2×20 VF display on the web page display screen 20, which has touch screen capabilities. In this embodiment, commands that were previously displayed on the 2×26 VF display are matched to a corresponding URL and a browser is used to render the page on the web page display screen 20. The web pages displayed contain touch-screen keys that effectively emulate hardware keys.

In one preferred embodiment of the claimed invention, a dictionary URL approach is used for translating the data messages into web page information. In this manner, data messages are “looked up” in a dictionary data file where they can be redirected to an attractive URL. The embedded processor 30 responds to requests on the I²C bus that were intended for the prior art enhanced player interface (EPI) VF display. The web page display screen 20 is not a passive display device like traditional PC monitors, but rather the display screen 20 must respond to commands with text type responses. These requests include initialization requests, status requests, and display requests. As each text data message to be displayed is passed into the embedded processor 30, the processor 30 calls a URL Dictionary to look up a URL with which to replace the text data message. Once the substitution is complete, the embedded processor 30 instructs the web page display screen 20 to present (or navigate to) the appropriate web page.

Accordingly, a URL Dictionary component is used to map a text string, sent from the embedded processor 30 and intended for the display on the 2×20 VF display, to a URL that can be used to display a much more visually enhanced graphical representation of the same message. Thus, the URL Dictionary component contains a listing of the possible text messages to be supported that could be sent from the embedded processor 30, and a mapping to a set of the desired eye-catching, web content to be displayed on the web page display screen 20. In this event that a message is not in the URL Dictionary, such a message is mapping to a page that substitutes for the 2-line mode.

In the preferred embodiments described above, the embedded processor 30 of the embedded additional user interface 10 reads incoming I²C data messages, translates the I²C data messages into a web authoring language (e.g., HTML, DHTML, XML, MACROMEDIA FLASH), and maps the newly translated web page data message to the web page display screen 20. Additionally, the embedded additional user interface 10 can also read incoming data messages that are already in a web authoring language (e.g., HTML, DHTML, XML, MACROMEDIA FLASH), and map this web page data to the web page display screen 20. Further, and highly advantageously, a preferred embodiment of the claimed invention also allows casinos that are using the embedded additional user interface 10 to design and use their own content, thereby giving the casinos the ability to decide what the web page presented on the web page display screen 20 of the user interface 10 will look like.

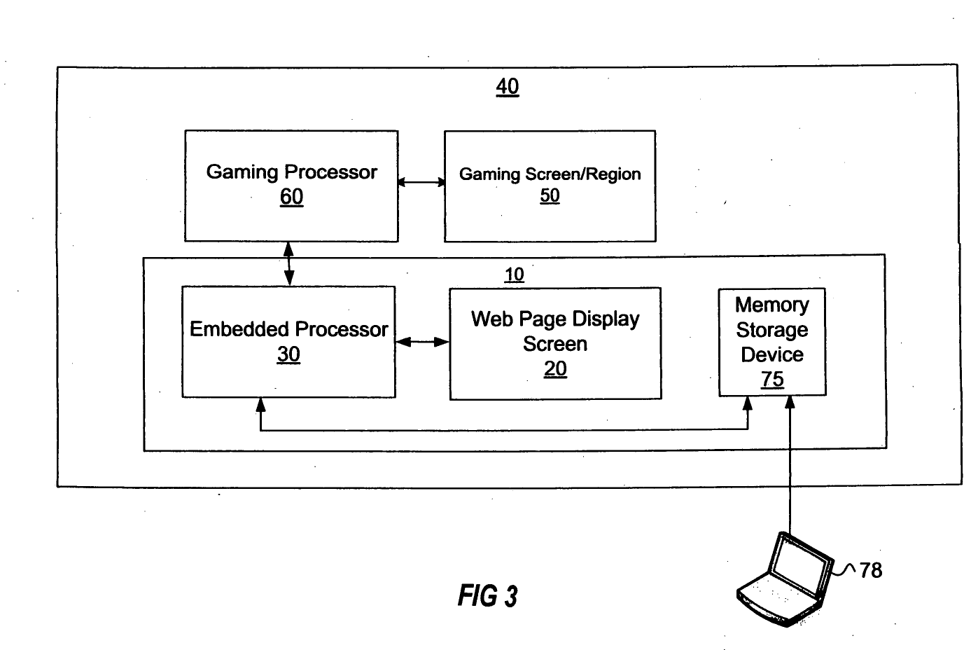

Referring now to FIG. 3, in this preferred embodiment, content may be locally downloaded. Specifically, in one preferred embodiment, the content is updated through a physical USB (or other connection) that is used to download the new content. In one preferred embodiment, the data on the alterable media 75 can be accessed by connecting a separate computer 78 (or other handheld device) to the network adapter port of the embedded additional user interface 10. This embodiment allows updating the contents of the operating system, changing the operating system itself, and receiving data from the alterable media 75. Physical removal of the alterable media 75 is also still an option for update and inspection of files on the embedded additional user interface 10.

In one preferred embodiment, a portable computer (or other handheld device) is used store and publish data content to the alterable media 75 on the embedded additional user interface 10, as well as to receiving data from the alterable media 75 on the embedded additional user interface. In this embodiment, all content on the embedded additional user interface 10 is authenticated as if it were a gaming machine.

In another preferred embodiment, a network adapter port is run on the embedded computer board of the user interface 10. This embodiment also includes a boot loader. Further, in this embodiment, the portable computer 78 (described above) includes components for use in uploading data to, and downloading data from, the alterable media 75 on the embedded additional user interface 10. Specifically, the components that run on the portable computer 78 are for moving new data content to the embedded additional user interface 10, and for validation and verification of the data content that is on the embedded additional user interface. Preferably, all data that is used to update the alterable media 75 moves to or from the embedded additional user interface 10 over the single built in network adapter port on the board.

Prior to the advent of the embedded additional user interface 10 of the claimed invention, gaming regulators would have been unwilling to allow casino operators to design their own content. However, due to the cryptographic technology implemented by the embedded processor 30 in the embedded additional user interface 10, a certification process is provided by the claimed invention with sufficient security for gaming regulators to allow casino operators to design their own content. Specifically, in one preferred embodiment, the certification process offered ensures authentication and non-repudiation of the casino operator designed web content. Preferably, in the claimed invention the certification process provided further ensures auditability and traceability. Various cryptographic technologies, such as authentication and non-repudiation (described herein below), are utilized in preferred embodiments of the claimed invention, to provide sufficient security for gaming regulators to allow casino operators to design their own content.

In one preferred embodiment, this certification process is used to certify “signed content” (created by the casino owners) in the same manner that a “signed program” is certified. Preferably, PKI (Public Key Infrastructure) is utilized in the certification process. PKI is a system of digital certificates, Certificate Authorities, and other registration authorities that verify authenticity and validity. In one preferred embodiment, a “new tier” or derivative PKI is created that is rooted in the primary PKI and that leverages the capabilities of the certificate (e.g., a×509 certificate) that allow for limited access. Thus, this preferred embodiment allows the attributes within the certificate to be used to provide “levels” of code access and acceptance in the gaming industry.

In one embodiment, the content is protected by digital signature verification using DSA (Digital Signature Algorithm) or RSA (Rivest-Shamir-Adleman) technology. In this regard, the content is preferably protected using digital signature verification so that any unauthorized changes are easily identifiable. A digital signature is the digital equivalent of a handwritten signature in that it binds a trusted authority's identity to a piece of information. A digital signature scheme typically consists of a signature creation algorithm and an associated verification algorithm. The digital signature creation algorithm is used to produce a digital signature. The digital signature verification algorithm is used to verify that a digital signature is authentic (i.e., that it was indeed created by the specified entity). In another embodiment, the content is protected using other suitable technology.

In one preferred embodiment, a Secure Hash Function-1 (SHA-1), or better, is used to compute a 160-bit hash value from the data content or firmware contents. This 160-bit hash value, which is also called an abbreviated bit string, is then processed to create a signature of the game data using a one-way, private signature key technique, called Digital Signature Algorithm (DSA). The DSA uses a private key of a private key/public key pair, and randomly or pseudo-randomly generated integers, to produce a 320-bit signature of the 160-bit hash value of the data content or firmware contents. This signature is stored in the database in addition to the identification number.

In another preferred embodiment, the claimed invention utilizes a Message Authentication Code (MAC). A Message Authentication Code is a specific type of message digest in which a secret key is included as part of the fingerprint. Whereas a normal digest consists of a hash (data), the MAC consists of a hash (key +data). Thus, a MAC is a bit string that is a function of both data (either plaintext or ciphertext) and a secret key. A Message Authentication Code is attached to data in order to allow data authentication. Further, a MAC may be used to simultaneously verify both the data integrity and the authenticity of a message. Typically, a Message Authentication Code (MAC) is a one-way hash function that takes as input both a symmetric key and some data. A symmetric-key algorithm is an algorithm for cryptography that uses the same cryptographic key to encrypt and decrypt the message.

A Message Authentication Code can be generated faster than using digital signature verification technology; however, a Message Authentication Code is not as robust as digital signature verification technology. Thus, when speed of processing is critical the use of a Message Authentication Code provides an advantage, because it can be created and stored more rapidly than digital signature verification technology.

In one preferred embodiment, the authentication technique utilized is a BKEY (electronic key) device. A BKEY is an electronic identifier that is tied to a particular trusted authority. In this manner, any adding, accessing, or modification of content that is made using a BKEY for authentication is linked to the specific trusted authority to which that BKEY is associated. Accordingly, an audit trail is thereby established for regulators and/or other entities that require this kind of data or system authentication.

Another preferred embodiment of the verification system utilizes “component bindings” for verification using cryptographic security. In component binding, some components come equipped with unalterable serial numbers. Additionally, components such as web content or the game cabinet may also be given another random identification number by the owner. Other components in the system, such as the CMOS memory in the motherboard, the hard drive, and the non-volatile RAM, are also issued random identification numbers. When all or some of these numbers are secured together collectively in a grouping, this protected grouping is referred to as a “binding.” Each component of the machine contains its portion of the binding.

In one such preferred embodiment, every critical log entry made to the content is signed with a Hashed Message Authorization Code (HMAC) that is based on the entry itself, and on the individual binding codes. In this manner, the security produced by the bindings ensures that log entries that are made cannot be falsified or repudiated.

After the critical gaming and/or system components are selected, given individual identifiers, and combined into a protected grouping that is secured using the component “bindings,” any changes to those components will then be detected, authorized, and logged. For example, content within the binding is digitally signed (SHA-1) using the key derived from the bindings. This signature is verified whenever an entry is made to a component within the binding. If the signature is wrong, this security violation and the violator are noted, but typically the entry is not prohibited. In other embodiments, the entry may be prohibited as well. Thus, the component binding produces a cryptographic audit trail of the trusted authority making changes to any of the components within the binding.

Moreover, bindings ensure that the critical components of a gaming machine system, or the content utilized therein, that have been selected to be components within the binding have not been swapped or altered in an unauthorized manner. Preferably, bindings use unique identification numbers that are assigned to vital parts of the gaming platform including, by way of example only, and not by way of limitation, the cabinet, motherboard, specific software, non-volatile RAM card, content (data), and hard drive. These identification numbers combined in a cryptographic manner to form a “binding” that protects and virtually encloses the included components, such that no component within the binding can be modified, removed, or replaced without creating an audit trail and requiring authentication. Thus, for one of these components within the binding to be changed, appropriate authentication is required and a log file entry is made documenting the activity and the identity of the trusted authority making the change. In one preferred embodiment, a specific level of BKEY clearance or classification is required to make specific changes.

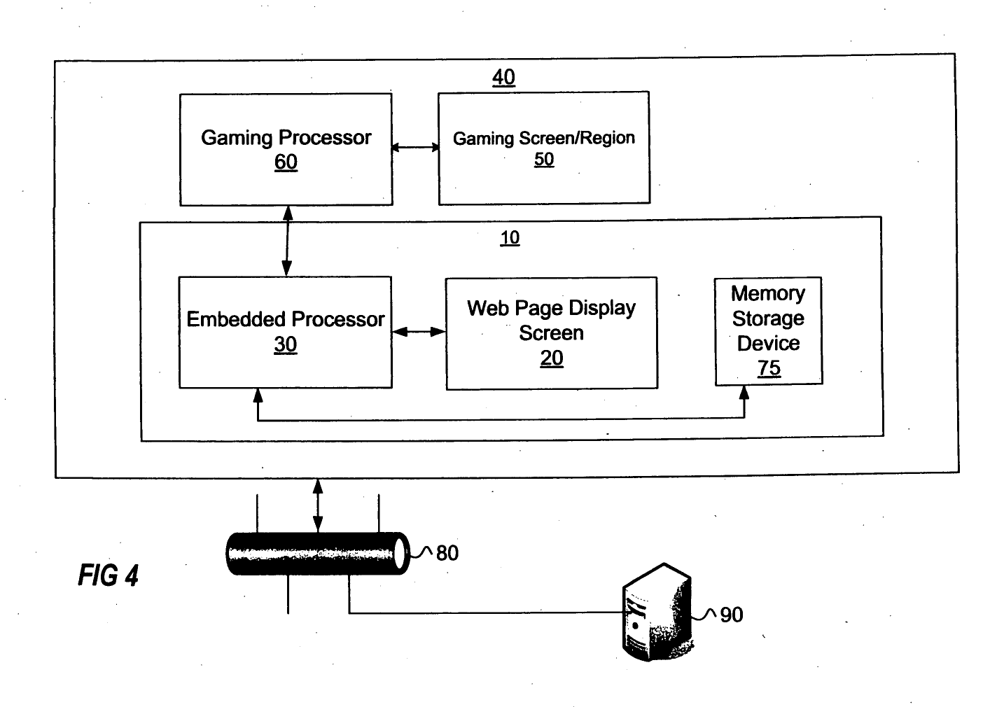

Referring now to FIG. 4, in one preferred embodiment, the embedded additional user interface 10 connects to an Ethernet-networked backbone 80 instead of a local system network. Currently, casino networks are not Ethernet, but rather are smaller, more simplistic local system networks. Thus, in this Ethernet-networked backbone 80 embodiment, the current system network is replaced by an industry standard Ethernet backbone, such as 10/100 base T Ethernet running over Cat 3, 4, 5, 6, or higher. Thus, a standard 10/100 base T Ethernet card is added to the processor in this embodiment. Preferably, the network employs TCP/IP, HTTP, and XML messaging or a variant of XML. Nevertheless any suitable protocol may be used.

Further, in another preferred embodiment, the embedded additional user interface 10 connects to a full featured, back end, download configuration server 90 through the above-described Ethernet-networked backbone 80 as shown in FIG. 4. In such an embodiment, the full-featured server 90 can schedule downloads of content (gaming or otherwise) as well as upload information from the gaming machines 40, such as what options the gaming machines 40 currently possess. Accordingly, in a preferred embodiment, the primary use of the server 90 is as data download and data retrieval server. While this server 90 does upload and download web content style information, it is typically not connected to the World Wide Web. This server 90 must be authenticated Oust like a gaming machine) to make the content served to the embedded additional user interface 10 acceptable to the gaming regulators. Preferably, utilization of the Ethernet-networked backbone 80 and the server 90 provides many system benefits, including but not limited to reliability, maintainability, security, content staging, content testing, deployment procedures, and incident recovery. In one embodiment, deliverables also preferably include content templates and guidelines for casino owners and operators to create their own web content for deployment to the web server. In one embodiment, the web server 90 has its content authenticated in the same manner as the embedded additional user interface 10 to allow content to be downloaded to the web page display screen 20.

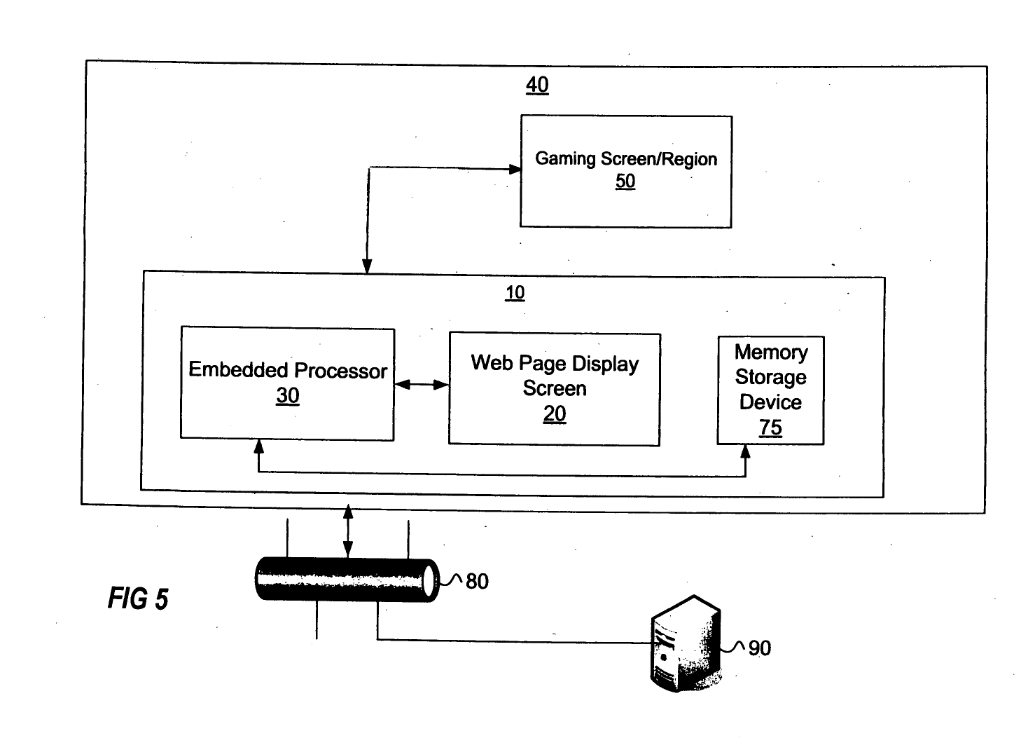

Referring now to FIG. 5, in another preferred embodiment of the claimed invention, the functions previously performed by the gaming monitoring unit 65, as shown in FIGS. 1-4, of the gaming machine 40 are supported by the embedded processor 30 of the embedded additional user interface 10. Otherwise stated, the GMU code is transitioned from the gaming monitoring unit 65 into the embedded processor 30 in the embedded additional user interface 10. Accordingly, such a configuration removes the need for the gaming monitoring unit 65 in the gaming machine 40. This results in a significant reduction in the amount and complexity of the hardware, as well as completing a phased transition of more traditional style gaming machines into more modernized upgraded gaming machines.

Thus, in such a preferred embodiment, the claimed invention is directed towards an embedded additional user interface 10 that is incorporated into a gaming machine 30, the gaming machine in turn including a gaming screen 50 or other appropriate gaming region (e.g., spinning reels), but does not include a gaming monitoring unit 65. Such an embedded additional user interface 10 still includes a web content capable display screen 20 and an embedded processor 30. Once again, the web content capable display screen 20 presents web information to a user via the display screen. The embedded processor 30 preferably utilizes an internal operating system. Furthermore, in this embodiment the embedded processor 30 additionally includes standard gaming monitoring unit finctionality (GMU code), since it replaces the gaming monitoring unit 65 in the gaming machine 40. As before, the embedded processor 30 reads incoming data, translates the data into a web protocol (web authoring language), if necessary, and maps the data to the web content capable display screen 20.

In one embodiment, the embedded additional user interface 10, the messages are flashed (e.g., animation, multimedia, and the like) to the player within the web page display screen 20 while the gaming screen 50 is used for game play. These web page style messages can be set at virtually any desired length, format, or style. A message might display, for example, “Welcome to Harrah's Las Vegas! You have 1200 bonus points. Would you like to make a hotel or dinner reservation?” Importantly, while a previous utilized EPI bus would only been capable of scrolling this message in one-quarter inch (0.25″) tall monochrome text, in contrast, the web page display screen 20 would “flash” this message in bright red, white, black, and green animated format, on six inch (6.0″) by three inch (3.0″) color graphic display. Additionally, in some embodiments, inserting a player identification card into a card reader and/or selecting a player services button activates additional player services functionality.

In one exemplary embodiment of the embedded additional user interface 10 that utilizes a card reader (or other identification technique, such as a player ID code) to recognize a particular player, the web page display screen 20 displays an eye-catching, web page style message to that player, for example, “Welcome, Mr. Smith!” in response to identifying Mr. Smith. Preferably, the web page display screen 20 also has touch screen capabilities that include, by way of example only, and not by way of limitation, “Beverages,” “Change,” “Services,” “Transactions,” and “Return to Game.” In one embodiment, each of the touch screen icon buttons, when selected, launches a new full screen display within the web page display screen 20 for the player.

For example, in one embodiment, when the “Transactions” touch screen icon button is selected, a new screen is activated that includes the web page style message, “Mr. Smith, Account Balance: Bonus Points =1200, Player Funds=$150, Available Credit=$850, Casino Matching Funds Available=$25,” as well as the “Return to Game” icon button 120. As a further example, when the player selects a “Cashless Withdraw” button in another embodiment, a new screen is activated that includes a touch screen keypad and flashes the question, “How much do you want?” as well as “Enter,” “Clear,” and “Back” buttons. Preferably, this interface also includes an “Information” button that, when selected, launches a new screen within the web page display screen 20 that provides answers to frequently asked questions and other useful information. Moreover, the web page display screen 20 preferably also includes a “History” button that, when selected, launches a new screen within the web page display screen 20 that provides a history log of all transactions and other actions performed on that gaming machine 40.

In accordance with another preferred embodiment, the claimed invention is directed towards a method for increasing user excitement relating to a gaming machine by providing a richer gaming experience via an embedded additional user interface that is incorporated into the gaming machine. The method preferably includes: receiving a serial data message (e.g., an I²C data message) containing enhanced player information over a serial communication bus (e.g., an I²C) bus in the embedded additional user interface 10; translating the data message (using the embedded processor 30) into a web authoring language; and mapping the data message to the web page display screen 20, wherein the display screen presents web page information to a user via the display screen.

The potential advantages of utilizing the embedded additional user interface 10 of the claimed invention are numerous. These potential advantages include, by way of example only, and not by way of limitation; providing animated and/or multimedia web style content, providing fonts and icons which are larger and more aesthetically appealing; providing special services to players, (e.g., multiple languages, assistance for handicapped individuals); facilitating interactive uses of the web page display screen 20; providing the ability to customize the “look and feel” of the web page display screen 20 for players and casino employees; increased player excitement and participation; and simplified replaceability and/or upgradeability from an EPI bus or other similar non-web page style components.

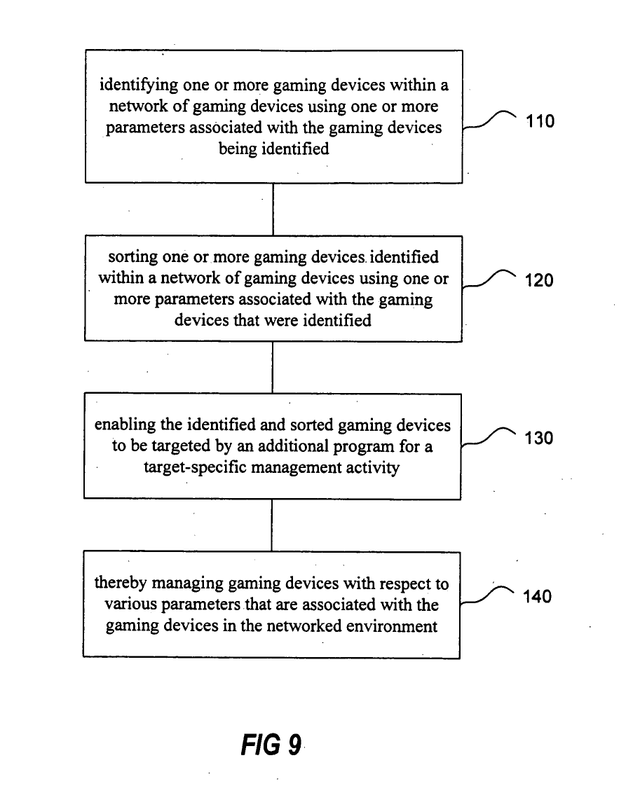

Referring now to FIG. 9, in accordance with another preferred embodiment, this invention is directed towards a method for managing gaming devices 6 in a networked environment using a computer datastore 4. The method includes: (1) at Step 110, identifying one or more gaming devices 6 within a network of gaming devices using one or more parameters 8 associated with the gaming devices being identified; (2) at Step 120, sorting one or more gaming devices 6 identified within a network of gaming devices using one or more parameters 8 associated with the gaming devices that were identified; (3) at Step 130, enabling the identified and sorted gaming devices 6 to be targeted by an additional application/program for a target-specific management activity; and (4) at Step 140, managing gaming devices 6 with respect to various parameters 8 that are associated with the gaming devices in the networked environment.

Although the invention has been described in language specific to computer structural features, methodological acts, and by computer readable media, it is to be understood that the invention defined in the appended claims is not necessarily limited to the specific structures, acts, or media described. Therefore, the specific structural features, acts and mediums are disclosed as exemplary embodiments implementing the claimed invention. Furthermore, the various embodiments described above are provided by way of illustration only and should not be construed to limit the invention. Those skilled in the art will readily recognize various modifications and changes that may be made to the claimed invention without following the example embodiments and applications illustrated and described herein, and without departing from the true spirit and scope of the claimed invention, which is set forth in the following claims.

1. A method for managing gaming devices in a networked environment using a computer datastore, the method comprising:
identifying one or more gaming devices within a network of gaming devices using one or more parameters associated with the gaming devices being identified,
sorting one or more gaming devices identified within a network of gaming devices using one or more parameters associated with the gaming devices that were identified, and
enabling the identified and sorted gaming devices to be targeted by an additional application/program for a target-specific management activity;
thereby managing gaming devices with respect to various parameters that are associated with the gaming devices in the networked environment.

2. The method of claim 1, wherein the gaming devices are selected from a group consisting of: electronic gaming machines, game monitoring units, embedded additional user interface, bill dispensers, coin acceptors, hoppers, and printers, and embedded components.

3. The method of claim 1, wherein the gaming devices are any uniquely identifiable entity on the gaming floor.

4. The method of claim 1, wherein the datastore is selected from a group consisting of: a relational database, an object database, a flat file, an ASCII list, registry entries, an XML file, and data listings.

5. The method of claim 1, wherein the target-specific management activity is selected from a group consisting of: tracking, sorting, managing, polling, downloading, verifying, authenticating, updating, and reconfiguring.

6. The method of claim 5, wherein all gaming devices that are identified and sorted into a particular group are targeted for a specific code download.

7. The method of claim 5, wherein all game monitoring units that are identified and sorted into a particular group are targeted for a particular code revision while those game monitoring units outside of the group are ignored.

8. The method of claim 5, wherein all embedded additional user interfaces installed into gaming machines that are located in a particular physical location in a property are identified, receive downloaded content, and have said downloaded content authenticated, after which the embedded additional user interfaces in said physical location are reconfigured, while all of the embedded additional user interfaces outside of said physical location are ignored.

9. The method of claim 1, wherein the computer datastore identifies, sorts, and groups gaming floor inventory for inventory management.

10. The method of claim 1, wherein the computer datastore maintains up-to-date information on gaming floor inventory for one or more parameters associated with the gaming devices.

11. The method of claim 1, wherein the parameters are selected from a group consisting of: the name of the gaming device, the hardware revision of the gaming device, the firmware revision of the gaming device, the content on the gaming device, the make/model of the gaming device, the physical location of the gaming device, component list, and application logs, access logs.

12. The method of claim 2, wherein the embedded additional user interface is incorporated into a gaming machine, wherein the gaming machine includes a gaming presentation and gaming processor, the embedded additional user interface comprising:
a web content capable display screen, wherein the display screen presents web information to a user via the display screen; and
an embedded processor that employs an internal operating system and communicates with the gaming processor, wherein the embedded processor reads incoming data, translates the data into a web protocol, if necessary, and maps the data to the web content capable display screen;
whereby the web content capable display screen increases user excitement by providing a richer gaming experience.

13. A method for managing gaming devices in a networked environment using a computer datastore, the method comprising:
identifying one or more gaming devices within a network of gaming devices using one or more parameters associated with the gaming devices being identified,
grouping one or more gaming devices identified within a network of gaming devices using one or more parameters associated with the gaming devices that were identified, and
enabling the identified and sorted gaming devices to be targeted by an additional application/program for a target-specific management activity while the non-identified and sorted gaming devices are not targeted by an additional application/program for the target-specific management activity;
thereby managing gaming devices with respect to various parameters that are associated with the gaming devices in the networked environment.

14. The method of claim 13, wherein the gaming devices are selected from a group consisting of: electronic gaming machines, game monitoring units, embedded additional user interface, and embedded components.

15. The method of claim 13, wherein the gaming devices are any uniquely identifiable entity on the gaming floor.

16. The method of claim 13, wherein the datastore is selected from a group consisting of: a relational database, an object database, a flat file, an ASCII list, registry entries, an XML file, and data listings.

17. The method of claim 13, wherein the target-specific management activity is selected from a group consisting of: tracking, sorting, managing, polling, downloading, verifying, authenticating, updating, and reconfiguring.

18. The method of claim 17, wherein all gaming devices that are identified and sorted into a particular group are targeted for a specific code download.

19. The method of claim 13, wherein the computer datastore identifies, sorts, and groups gaming floor inventory for inventory management.

20. The method of claim 13, wherein the computer datastore maintains up-to-date information on gaming floor inventory for one or more parameters associated with the gaming devices.

21. The method of claim 13, wherein the parameters are selected from a group consisting of: the name of the gaming device, the hardware revision of the gaming device, the firmware revision of the gaming device, the content on the gaming device, the make/model of the gaming device, and the physical location of the gaming device.

22. A system for managing gaming devices in a networked environment using a computer datastore, the datastore comprising:
means for identifying one or more gaming devices within a network of gaming devices using one or more parameters associated with the gaming devices being identified,
means for sorting one or more gaming devices identified within a network of gaming devices using one or more parameters associated with the gaming devices that were identified, and
means for enabling the identified and sorted gaming devices to be targeted by an additional application/program for a target-specific management activity;
thereby managing gaming devices with respect to various parameters that are associated with the gaming devices in the networked environment.

23. The system of claim 22, wherein the gaming devices are selected from a group consisting of: electronic gaming machines, game monitoring units, embedded additional user interfaces, and embedded components.

24. The system of claim 22, wherein the gaming devices are any uniquely identifiable entity on the gaming floor.

25. The system of claim 22, wherein the datastore is selected from a group consisting of: a relational database, an object database, a flat file, an ASCII list, registry entries, an XML file, and data listings.

26. The system of claim 22, wherein the target-specific management activity is selected from a group consisting of: tracking, sorting, managing, polling, downloading, verifying, authenticating, updating, and reconfiguring.

27. The system of claim 26, wherein all gaming devices that are identified and sorted into a particular group are targeted for a specific code download.

28. The system of claim 22, wherein the computer datastore identifies, sorts, and groups gaming floor inventory for inventory management.

29. The system of claim 22, wherein the computer datastore maintains up-to-date information on gaming floor inventory for one or more parameters associated with the gaming devices.

30. The system of claim 22, wherein the parameters are selected from a group consisting of: the name of the gaming device, the hardware revision of the gaming device, the firmware revision of the gaming device, the content on the gaming device, the make/model of the gaming device, and the physical location of the gaming device.
